(19) United States
(12) Patent Application Publication
(10) Pub. No.: US 2016/0150212 A1
(43) Pub. Date: May 26, 2016

(54) LIVE SELECTIVE ADAPTIVE BANDWIDTH

(71) Applicant: SONY CORPORATION, Tokyo (JP)

(72) Inventors: Danilo Silva Moura, Culver City, CA (US); Prabhu Anbananthan, Cerritos, CA (US); Prateek Tandon, Westlake Village, CA (US)

(21) Appl. No.: 14/940,089

(22) Filed: Nov. 12, 2015

Related U.S. Application Data
(60) Provisional application No. 62/123,778, filed on Nov. 26, 2014.

(51) Int. Cl. H04N 13/00; H04N 19/174; H04N 19/167; G06T 19/00

(52) U.S. Cl. CPC H04N 13/0048; G06T 19/006; H04N 19/174; H04N 13/0059; H04N 19/167

(57) ABSTRACT

A live selective adaptive bandwidth method enables transmission of three dimensional 360 degree virtual reality content by slicing the content and utilizing different resolutions of the content, where content in the visible area of the user is a higher resolution than content in the non-visible area of the user. Additionally, network information such as available bandwidth is used in determining which resolution content to be transmitted.

### CROSS-REFERENCE TO RELATED APPLICATION(S)

This application claims priority under 35 U.S.C. §119(e) of the U.S. Provisional Patent Application Ser. No. 62/123,778, filed Nov. 26, 2014 and titled, “LIVE SELECTIVE ADAPTIVE BANDWIDTH,” which is hereby incorporated by reference in its entirety for all purposes.

### FIELD OF THE INVENTION

The present invention relates to the field of network bandwidth, and more particularly, to selective adaptive network bandwidth.

### BACKGROUND OF THE INVENTION

Products such as Project Morpheus from Sony®, Gear VR from Samsung®, Oculus Rift from Facebook® and many others, will be available in the hands of millions of consumers. In addition to games, users can experience being immersed into photorealistic 3D 360 degree videos.

The process of generating 360 degree video includes having multiple camcorders recording in all directions, with a bit of frame overlap in each lens. Software rips each of the video camera streams into single frames and stitches all pieces in order to create a full equirectangular panorama. Those panoramic frames are then run back at the capture frame rate to generate the 360 degree video. Two 360 degree video streams, one per eye, are used in order to generate the 360 degree stereoscopic effect.

In order to achieve a high quality 360 degree Virtual Reality (VR) video. The playback of 60 frames per second at a resolution of 8192×4096 pixels, per eye, is used. This is very challenging for today's Internet average broadband speed and current processing power of devices. As a result, most video is distributed at a 1080p or 4K quality, limiting the quality.

Streaming 23 Pixels Per Degree (PPD) (8K) resolution, by itself, is a challenge as it uses four times the resolution and bandwidth of Ultra High Definition (4K).

### SUMMARY OF THE INVENTION

The summary of the invention described herein merely provides exemplary embodiments and is not meant to be limiting in any manner.

A live selective adaptive bandwidth method enables transmission of three dimensional 360 degree virtual reality content by slicing the content and utilizing different resolutions of the content, where content in the visible area of the user is a higher resolution than content in the non-visible area of the user. Additionally, network information such as available bandwidth is used in determining which resolution content to be transmitted.

In one aspect, a method programmed in a non-transitory memory of a device comprises receiving three dimensional 360 degree virtual reality content, wherein the three dimensional 360 degree virtual reality content includes a high quality component and a lower quality component than the high quality component and displaying the three dimensional 360 degree virtual reality content. The high quality component and the lower quality component each include a slice of the content. The high quality component includes content the user is viewing and the lower quality component includes the content the user is not viewing. The high quality component and the lower quality component are synchronized at a same timecode. The three dimensional 360 degree virtual reality content includes a plurality of qualities of content, and the quality of the content is selected based on a visible area and network information. The three dimensional 360 degree virtual reality content includes a plurality of qualities of content, and the quality of the content for a non-visible area is a lowest quality, and the quality of the content for a visible area is based on remaining network bandwidth available. The three dimensional 360 degree virtual reality content includes a plurality of resolutions and bitrates of content.

In another aspect, an apparatus comprises a non-transitory memory for storing an application, the application for: receiving three dimensional 360 degree virtual reality content, wherein the three dimensional 360 degree virtual reality content includes a high quality component and a lower quality component than the high quality component and displaying the three dimensional 360 degree virtual reality content and a processing component coupled to the memory, the processing component configured for processing the application. The high quality component and the lower quality component each include a slice of the content. The high quality component includes content the user is viewing and the lower quality component includes the content the user is not viewing. The high quality component and the lower quality component are synchronized at a same timecode. The three dimensional 360 degree virtual reality content includes a plurality of qualities of content, and the quality of the content is selected based on a visible area and network information. The three dimensional 360 degree virtual reality content includes a plurality of qualities of content, and the quality of the content for a non-visible area is a lowest quality, and the quality of the content for a visible area is based on remaining network bandwidth available. The three dimensional 360 degree virtual reality content includes a plurality of resolutions and bitrates of content.

In another aspect, a method programmed in a non-transitory memory of a device comprises storing three dimensional 360 degree virtual reality content in a plurality of resolutions and transmitting the three dimensional 360 degree virtual reality content based on a visible area and a non-visible area and network information. The three dimensional 360 degree virtual reality content in the plurality of resolutions includes slices of high resolution content and slices of lower resolution content. The high resolution content and the lower resolution content are synchronized at a same timecode. Transmitting the three dimensional 360 degree virtual reality content includes transmitting high resolution content for the visible area and lower resolution content for the non-visible area. The resolution of the content for the non-visible area is a lowest resolution, and the resolution of the content for a visible area is based on remaining network bandwidth available. The network information includes network speed and network traffic.

In yet another aspect, an apparatus comprises a non-transitory memory for storing an application, the application for: storing three dimensional 360 degree virtual reality content in a plurality of resolutions and transmitting the three dimensional 360 degree virtual reality content based on a visible area and a non-visible area and network information and a processing component coupled to the memory, the processing component configured for processing the application. The three dimensional 360 degree virtual reality content in the plurality of resolutions includes slices of high resolution content and slices of lower resolution content. The high resolution content and the lower resolution content are synchronized at a same timecode. Transmitting the three dimensional 360 degree virtual reality content includes transmitting high resolution content for the visible area and lower resolution content for the non-visible area. The resolution of the content for the non-visible area is a lowest resolution, and the resolution of the content for a visible area is based on remaining network bandwidth available. The network information includes network speed and network traffic.

### BRIEF DESCRIPTION OF THE DRAWINGS

FIG. 1 illustrates a diagram of the average human eye stereo/binocular field of view.

FIG. 2 illustrates an example of a 4K image sliced into four 1024×2048 slices according to some embodiments.

FIG. 3 illustrates a diagram of an HMD according to some embodiments.

FIG. 4 illustrates experiences using the live selective adaptive bandwidth method according to some embodiments.

FIG. 5 illustrates an implementation of incorporating purchase opportunities in content according to some embodiments.

FIG. 6 illustrates a flowchart of a method of implementing a live selective adaptive bandwidth method according to some embodiments.

FIG. 7 illustrates a block diagram of an exemplary computing device configured to implement the live selective adaptive bandwidth method according to some embodiments.

FIG. 8 illustrates a network of devices configured to implement the live selective adaptive bandwidth method according to some embodiments.

### DETAILED DESCRIPTION OF THE PREFERRED EMBODIMENT

Virtual Reality (VR) video for sports/realistic content runs at 60 fps; 4K AVC streaming at 60 fps uses 15˜20 mbps, 4K AVC 3D streaming at 60 fps uses 30˜40 mbps, 8K AVC streaming uses 60˜80 mps, and 8K 3D AVC streaming uses 120˜160 mps. HEVC is able to reduce AVC bandwidth in half.

According to Akamai's state of the Internet, the average Internet Speed in the US and Canada could potentially support one stream in 4K, but not two, which is used in order to support the native stereoscopic capabilities of the Head-Mounted Display (HMD) devices.

Considering the bitrate to live stream two 8K files (160 mbps) will be more than 12 times higher than the average bitrate achievable on US and Canada, a different approach is used in order to deliver high quality live streams for VR HMD.

A selective adaptive live streaming standard for VR is able to be used.

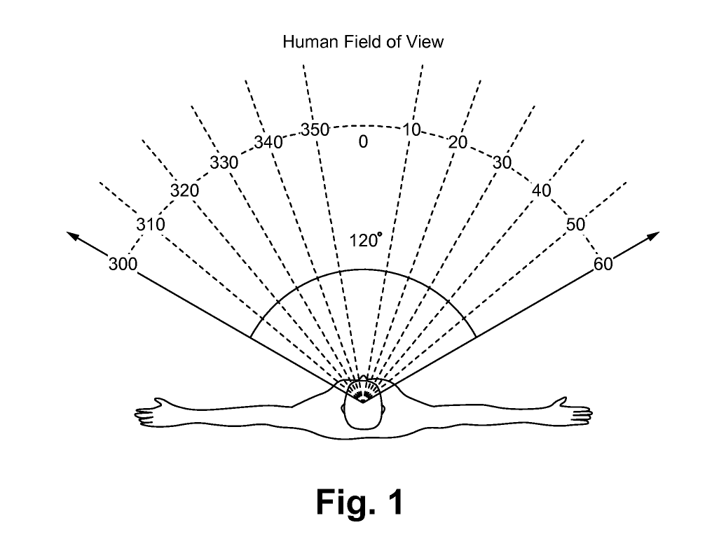

The average human eye stereo/binocular field of view is close to 120 degrees (for some it is greater or less), and the current HMD devices field of view is near 100 degrees (although this could be increased or decreased), so the user will not be able to see the whole 360 degrees sphere at same time. FIG. 1 shows a diagram of the average human eye stereo/binocular field of view.

This, combined with VR's high pixel density and frame rate speed demand, it is extremely inefficient to waste so much processing power, network bandwidth, gpu cycles and battery life to transmit and render more than 50% of the data that will not be seen by the user.

An extension to the Adaptive Bandwidth standard is described herein, in order to support the playback of multiple layers, synced at the same timecode, and, based on the user point of view, informed by the head mounted display, the video player will favoritize the bandwidth and resolution to the visible slices. For example, visible slices either have priority in terms of being transmitted first and/or quality priority (e.g., higher quality).

In case the user moves his head at a high speed, the result is to see a lower quality content (e.g., image/video) for a few seconds, until the player receives the information, from the HMD orientation, in order to favoritize that layer. In addition, quick head movements are very uncomfortable, especially in VR. For a normal user's head movement speed, a good, sharp resolution will able to be maintained by displaying in high quality only a few segments of the sphere without perceptual loss of quality.

In some embodiments, audio will not be muxed with the video slices. It will be its own separate stream.

### Current HLS Manifest File:

Only one layer of the below list is downloaded and played at the same time. Depending on the download speed of the segments, the quality will improve or decrease.

#EXTM3U
#EXT-X-VERSION:4VR
#EXT-X-STREAM-INF:PROGRAM-ID=1,BANDWIDTH=290400,CODECS=“avc1.42000d,
mp4a.40.2″,RESOLUTION = 384x216
http://example.url.akamaidhd.net/hls/live/220453/grc2014hlstest/masterhls1.m3u8
#EXT-X-STREAM-INF:PROGRAM-ID=1,BANDWIDTH=1320000,CODECS=“avc1.77.30,
mp4a.40.2″,RESOLUTION = 640x360
http://example.url.akamaidhd.net/hls/live/220453/grc2014hlstest/masterhls2.m3u8
#EXT-X-STREAM-INF:PROGRAM-ID=1,BANDWIDTH=1760000,CODECS=“avc1.4d001f,
mp4a.40.2″,RESOLUTION = 960x540
http://example.url.akamaidhd.net/hls/live/220453/grc2014hlstest/masterhls3.m3u8
#EXT-X-STREAM-INF:PROGRAM-ID=1,BANDWIDTH=2750000,CODECS=“avc1.4d001f,
mp4a.40.2″,RESOLUTION = 1280x720
http://example.url.akamaidhd.net/hls/live/220453/grc2014hlstest/masterhls4.m3u8
#EXT-X-STREAM-INF:PROGRAM-ID=1,BANDWIDTH=5880800,CODECS=“avc1.4d001f,
mp4a.40.2″,RESOLUTION = 1920x1080
http://example.url.akamaidhd.net/hls/live/220453/grc2014hlstest/masterhls5.m3u8
#EXT-X-STREAM-INF:PROGRAM-ID=1,BANDWIDTH=10880800,CODECS=“avc1.4d0020,
mp4a.40.2″,RESOLUTION = 2048 x1024
http://example.url.akamaidhd.net/hls/live/220453/grc2014hlstest/masterhls6.m3u8

### Extended VR HLS Manifest Files:

For each slice of the sphere, multiple layers with different resolutions and bitrates will also be used as shown in the example above. Instead of this variation of quality being dependent only on the current user network speed, it will also have the influence of the HMD orientation inside the 360 degree sphere, for prioritization. This is implemented by the player having the ability to play 1 audio stream and 4 video streams for 2D content and 8 video streams for 3D, as represented below. For 3D playback, L will represent the Left sphere and R the Right sphere.

VR Master HLS Definition:
#EXTM3U
#EXT-X-VERSION:4VR
#EXT-X-STREAM-INF:PROGRAM-ID=1,CODECS=“mp4a.40.2″
http://example.url.akamaidhd.net/hls/live/220453/grc2014hlstest/VR_Master_Audio.m3u8
//This is the audio-only stream, which is used in sync, but independent from the video
#EXT-X-STREAM-INF:PROGRAM-ID=1,CODECS=“avc1.4200d”,SLICE=1,VISIBLE=YES
http://example.url.akamaidhd.net/hls/live/220453/grc2014hlstest/VRmaster_L_Slice1.m3u8
#EXT-X-STREAM-INF:PROGRAM-ID=1,CODECS=“avc1.4200d”,SLICE=1,VISIBLE=YES
http://example.url.akamaidhd.net/hls/live/220453/grc2014hlstest/VRmaster_R_Slice1.m3u8
#EXT-X-STREAM-INF:PROGRAM-ID=1,CODECS=“avc1.4200d”,SLICE=2,VISIBLE=YES
http://example.url.akamaidhd.net/hls/live/220453/grc2014hlstest/VRmaster_L_Slice2.m3u8
#EXT-X-STREAM-INF:PROGRAM-ID=1,CODECS=“avc1.4200d”,SLICE=2,VISIBLE=YES
http://example.url.akamaidhd.net/hls/live/220453/grc2014hlstest/VRmaster_R_Slice2.m3u8
#EXT-X-STREAM-INF:PROGRAM-ID=1,CODECS=“avc1.4200d”,SLICE=3,VISIBLE=YES
http://example.url.akamaidhd.net/hls/live/220453/grc2014hlstest/VRmaster_L_Slice3.m3u8
#EXT-X-STREAM-INF:PROGRAM-ID=1,CODECS=“avc1.4200d”,SLICE=3,VISIBLE=YES
http://example.url.akamaidhd.net/hls/live/220453/grc2014hlstest/VRmaster_R_Slice3.m3u8
#EXT-X-STREAM-INF:PROGRAM-ID=1,CODECS=“avc1.4200d”,SLICE=4,VISIBLE=YES
http://example.url.akamaidhd.net/hls/live/220453/grc2014hlstest/VRmaster_L_Slice4.m3u8
#EXT-X-STREAM-INF:PROGRAM-ID=1,CODECS=“avc1.4200d”,SLICE=4,VISIBLE=YES
http://example.url.akamaidhd.net/hls/live/220453/grc2014hlstest/VRmaster_R_Slice4.m3u8

Each one of the above sliced video layers will have their own adaptive layers, which will be prioritized by the tag VISIBLE [YES/NO]. Visible=NO means those layers will be played at the lowest bandwidth available.

#EXTM3U
#EXT-X-VERSION:4VR
#EXT-X-STREAM-INF:PROGRAM-ID1 ,BANDWIDTH=290400,CODECS=“avc1.4200″,
RESOLUTION=384x216
http://example.url.akamaidhd.net/hls/live/220453/grc2014hlstest/masterhls1.m3u8
#EXT-X-STREAM-INF:PROGRAM-ID=1,BANDWIDTH=1320000,CODECS=“avc1.77.32″,
RESOLUTION = 640x360
http://example.url.akamaidhd.net/hls/live/220453/grc2014hlstest/masterhls2.m3u8
#EXT-X-STREAM-INF:PROGRAM-ID=1,BANDWIDTH=1760000,CODECS=“avc1.4d001f″,
RESOLUTION = 960x540
http://example.url.akamaidhd.net/hls/live/220453/grc2014hlstest/masterhls3.m3u8
#EXT-X-STREAM-INF:PROGRAM-ID=1,BANDWIDTH=2750000,CODECS=“avc1.4d001f″,
RESOLUTION = 1280x720
http://example.url.akamaidhd.net/hls/live/220453/grc2014hlstest/masterhls4.m3u8
#EXT-X-STREAM-INF:PROGRAM-ID=1,BANDWIDTH=5880800,CODECS=“avc1.4d001f″,
RESOLUTION = 1920x1080
http://example.url.akamaidhd.net/hls/live/220453/grc2014hlstest/masterhls5.m3u8
#EXT-X-STREAM-INF:PROGRAM-
ID=1,BANDWIDTH=10880800,CODECS=“avc1.4d0020″,RESOLUTION = 2048 x1024
http://example.url.akamaidhd.net/hls/live/220453/grc2014hlstest/masterhls6.m3u8

The first layer of manifest files will describe the amount of slices presented in the sphere. For efficiency, at least four vertical slices are described in the main VR manifest file. The attribute VRHMD visible=yes/no should be triggered by the HMD. Streams triggered as visible=no will be forced to the lowest quality layer available. The layer triggered as visible=yes should obtain remaining network bandwidth available.

The second layer of manifest files, for the visible streams, will behave in a similar way to the current specification, which will adapt depending on the available network speed resulting from carrying the two lowest layers as placeholders.

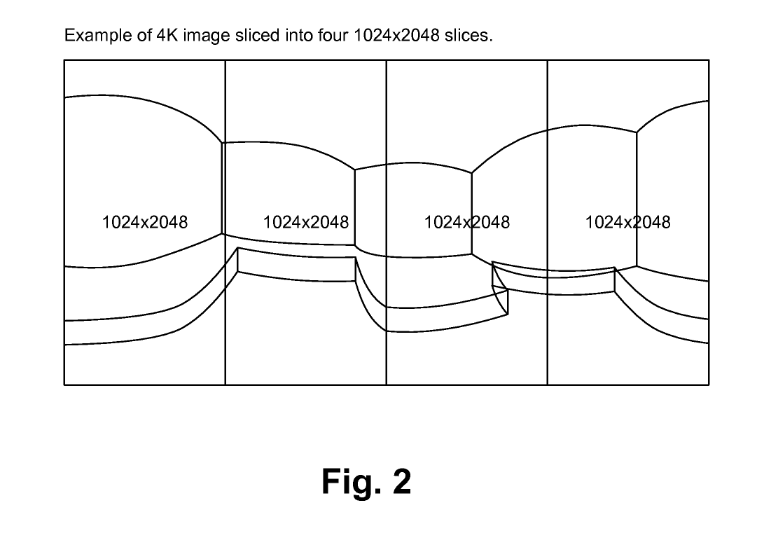

FIG. 2 illustrates an example of a 4K image sliced into four 1024×2048 slices according to some embodiments. Based on the orientation of the HMD, a live video will be automatically optimized for MPEG DASH (or HLS) VR streaming, enabling high quality 8K (23 PPD) content to be live broadcast for a VR headset or HMD (e.g., Morpheus), using only a fraction of the required video-memory buffer allocation and network bandwidth. It can be defined how media players will read the user HMD POV in order to determine which slices should have full resolution and a high bitrate.

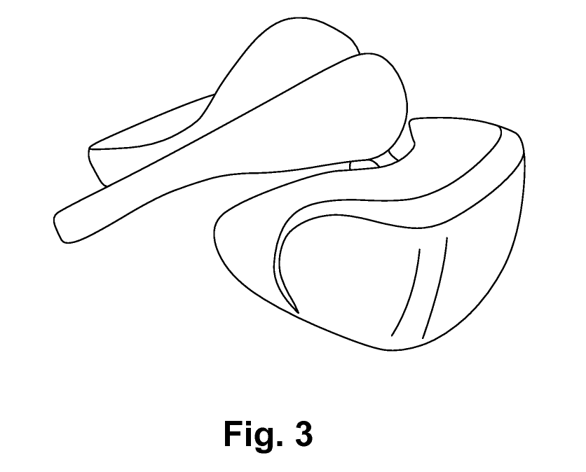

FIG. 3 illustrates a diagram of an HMD according to some embodiments. The HMD includes a display which is able to display the content as described herein. The HMD is able to include any other components in order to utilize the live selective adaptive bandwidth described herein.

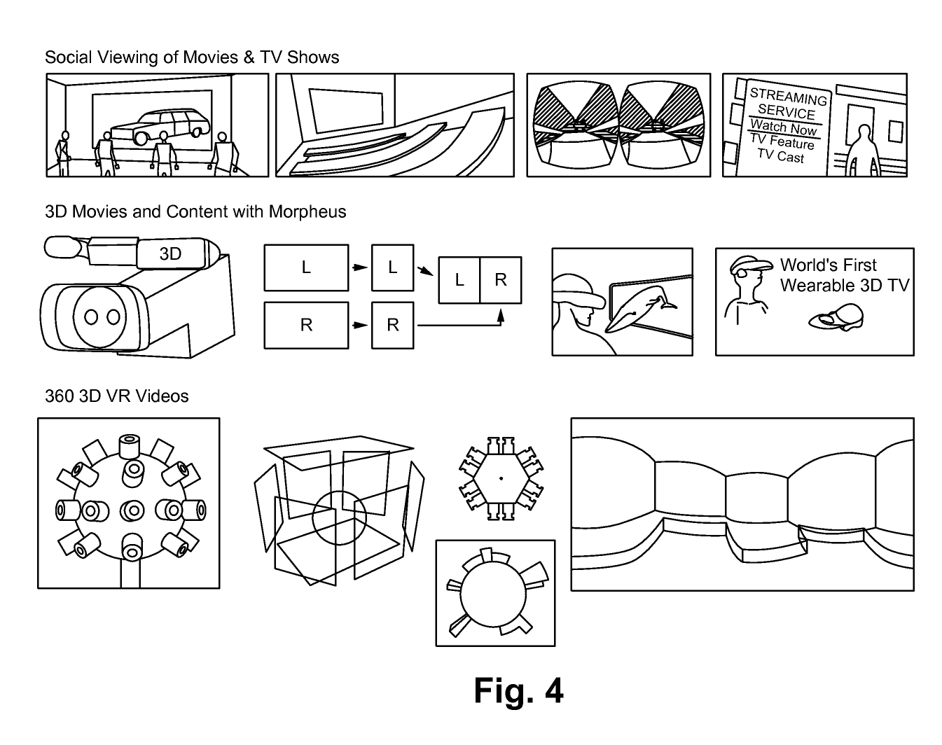

FIG. 4 illustrates experiences using the live selective adaptive bandwidth according to some embodiments. Social viewing of movies and television shows is possible such as in the theater and club game environments. 3D movies and content including 360 degree 3D VR videos are able to be viewed with an HMD.

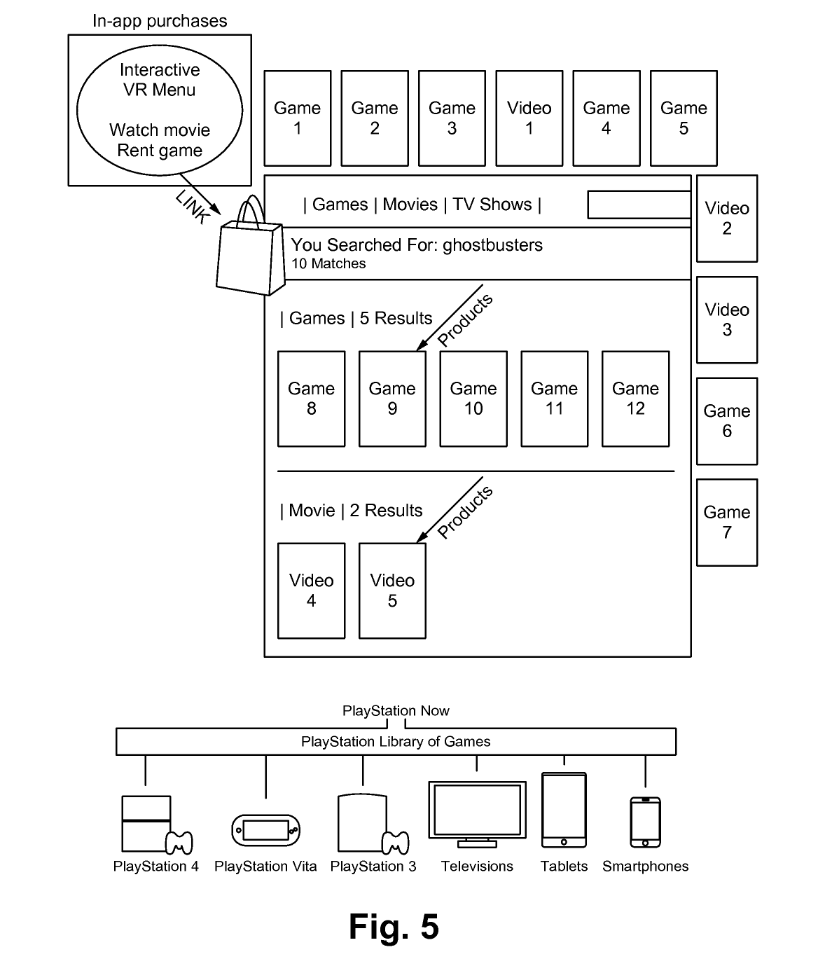

FIG. 5 illustrates an implementation of incorporating purchase opportunities in content according to some embodiments. For example, an interactive menu is able to appear in an application, movie, game or other content, to enable purchase or rent additional content/products. For example, while a user is watching a movie, an interactive VR menu appears which enables a user to rent a related game.

Exclusive interactive making of and behind the scenes 360 degree video content is able to be made for VR, including access to walkthroughs of famous locations and video game locations. In addition to Crackle, content form Live From PlayStation channels is able to be combined with PS4 live streams from Twitch TV and Ustream to generate social viewing experiences. The kinds of VR/social viewing experiences are also usable for watching live sporting events from the PlayStation Live Event Viewer or another viewer. The PS4 VR environment generates many possibilities for interactive advertising opportunities.

Using a 360 degree 3D video camera, with Steadicam, tours in a narrative VR experience are able to be generated. In some embodiments, the experience includes an interactive layer combined with the immersive POV with head tracking functionality. The interactive layer links to DLC and product pages in an online store (e.g., PlayStation® Store).

Users are able to select points of interest such as a Spiderman poster, Ghostbusters car, Breaking Bad RV, Jeopardy and Wheel of Fortune stages to purchase/rent/view the movies, TV shows and games. The interactive Ghostbusters Firehouse and Men In Black headquarters VR spaces include links to games and virtual goods in the online store.

The methods and implementations described herein are able to be utilized at amusement parks such as Disneyland® and at sporting events. For example, users are able to watch sporting events in 3D VR. The methods and implementations are also able to be utilized with concert experiences to give users a social and virtual experience of a live concert.

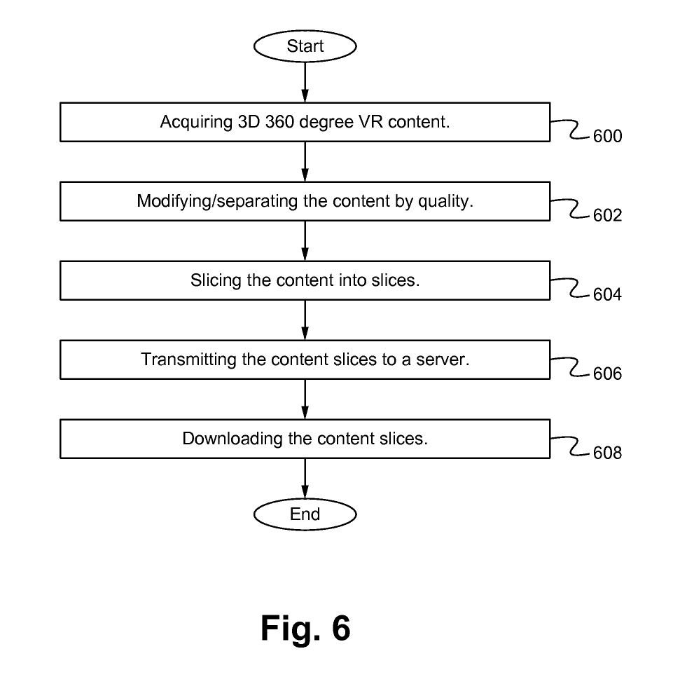

FIG. 6 illustrates a flowchart of a method of implementing a live selective adaptive bandwidth method according to some embodiments. In the step 600, 3D 360 degree VR content is acquired. For example, multiple 360 degree cameras or a specific 3D 360 degree camera system are used to capture content (e.g., video). In the step 602, the 3D 360 degree VR content is modified and/or separated into different quality content, and the different quality content is stored. For example, the content is separated into low quality (e.g., low resolution such as Standard Definition), middle quality (e.g., middle resolution such as 4K Ultra High Definition) and high quality (e.g., high resolution such as 8K Ultra High Definition) (although any number of levels of quality is possible). In some embodiments, the content is modified by acquiring high quality content and compressing the content into middle quality and low quality. In some embodiments, different quality videos are acquired simultaneously (e.g., low, mid and high quality content are all acquired simultaneously). In the step 604, the content is sliced into slices. For example, a 4K content is sliced into four 1024×2048 slices. In some embodiments, each quality level content is sliced into slices. For example, a high quality content and the corresponding middle quality and low quality content are sliced into corresponding slices as well. In the step 606, the content slices are transmitted (e.g., uploaded/stored) to a server device. In the step 608, the appropriate content slices are downloaded from the server device to a user device (e.g., HMD). The content is downloaded using the live selective adaptive bandwidth method. In some embodiments, for the part of the scene the user is not looking at, the lowest resolution version is downloaded, and for the visible part of the scene, the highest resolution version that is downloadable when factoring networking/computing capabilities/information (e.g., current traffic, CPU speed, network connection type). For example, during heavy traffic, the highest resolution downloadable may only be the third best resolution available. In some embodiments, a high resolution version of the part of the scene the user is looking at and a lower resolution version of the part of the scene that the user is not looking at are downloaded. The content to be downloaded and the resolution of the content to be downloaded changes as the user moves his head and/or the scene changes. In some embodiments, the HMD or other device determines where the user is looking (e.g., using coordinates on an image/video, the current direction of the HMD based on sensors or any other manner), and downloads and displays one or more slices that fill the user's view. For example, assuming a user's view is roughly 120 degrees (although it could be more or less, for example, a user's view could be 180 degrees or more), and each slice is 60 degrees of a viewing area, then two slices are in the user's view. The two slices in the user's view are high resolution content. The other 240 degrees (or 4 slices) are not in the user's view, and are a lower resolution content. In another example, where the user's view is 180 degrees, and each slice is 60 degrees of viewing area, then three slices are in the user's view and those three slices are high resolution content, while the other three slices are lower resolution content. In some embodiments, the slices in the user's view are a high resolution content, the slices just outside the user's view are a middle resolution content, and the slices behind the user are a low resolution content. For example, two slices (in front of the user) are high resolution, two slices (on the sides of the user or on either side of the two front slices) are middle resolution, and two slices (behind the user) are low resolution. By utilizing the live selective adaptive bandwidth method, the user views content in high resolution (or the highest resolution possible/practical based on the current circumstances). If the user moves his head, the system adapts and downloads high resolution content for that visual area. For rapid movements, low resolution content may be viewed briefly, but then the high resolution content is downloaded and displayed. In some embodiments, buffering is implemented in which high resolution content that is not currently being viewed is downloaded preemptively in case the user makes a rapid movement. In some embodiments, the buffering is intelligently performed using analysis (e.g., user analysis, content analysis) to predict when the user may turn his head. For example, the user is watching a football game using an HMD, and it is standard for a user to turn his head relatively quickly during a kickoff since the ball moves roughly 80 yards very quickly, so based on this information (e.g., at 15:00 left in the first quarter and the third quarter), more than just the viewable area is downloaded in high resolution. In some embodiments, fewer or additional steps are implemented. In some embodiments, the order of the steps is modified.

The method is able to be implemented using a variety of different devices. For example, acquiring the content occurs using cameras, separating the content and/or slicing the content occurs using a processing device which uploads the separated/sliced content to an online server (or the online server separates and/or slices the content), and the online server sends the separated/sliced content to an end-user device (e.g., game console, HMD, personal computer).

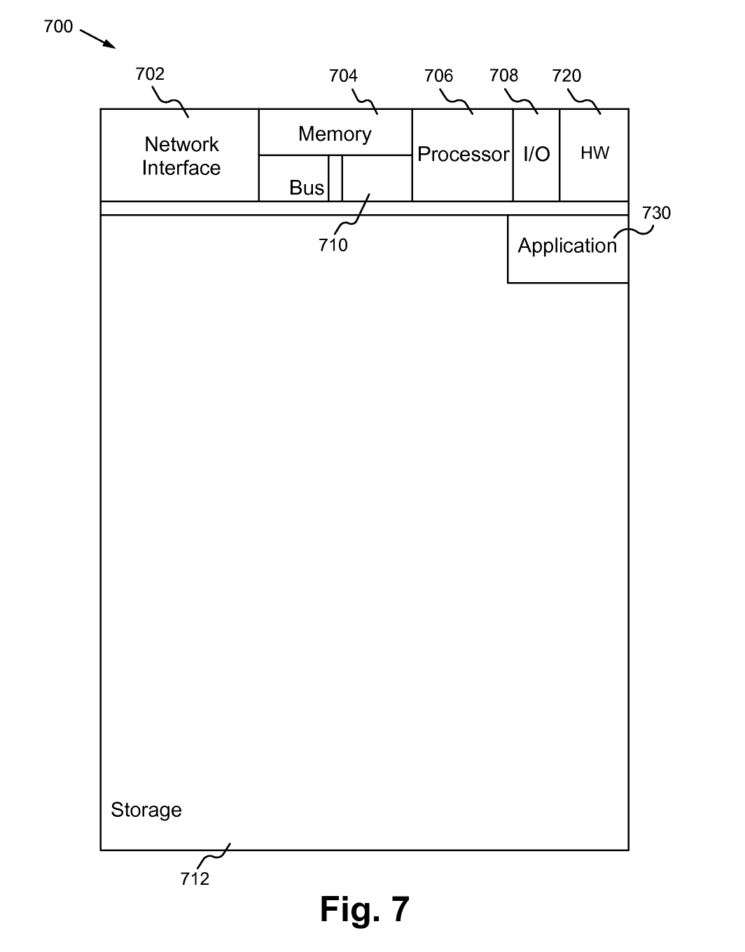

FIG. 7 illustrates a block diagram of an exemplary computing device configured to implement the live selective adaptive bandwidth method according to some embodiments. The computing device 700 is able to be used to acquire, store, compute, process, communicate and/or display information such as images, videos and audio. In general, a hardware structure suitable for implementing the computing device 700 includes a network interface 702, a memory 704, a processor 706, I/O device(s) 708, a bus 710 and a storage device 712. The choice of processor is not critical as long as a suitable processor with sufficient speed is chosen. The memory 704 is able to be any conventional computer memory known in the art. The storage device 712 is able to include a hard drive, CDROM, CDRW, DVD, DVDRW, High Definition disc/drive, ultra-HD drive, flash memory card or any other storage device. The computing device 700 is able to include one or more network interfaces 702. An example of a network interface includes a network card connected to an Ethernet or other type of LAN. The I/O device(s) 708 are able to include one or more of the following: keyboard, mouse, monitor, screen, printer, modem, touchscreen, button interface and other devices. Live selective adaptive bandwidth application(s) 730 used to implement the live selective adaptive bandwidth method are likely to be stored in the storage device 712 and memory 704 and processed as applications are typically processed. More or fewer components shown in FIG. 7 are able to be included in the computing device 700. In some embodiments, live selective adaptive bandwidth hardware 720 is included. Although the computing device 700 in FIG. 7 includes applications 730 and hardware 720 for the live selective adaptive bandwidth method, the live selective adaptive bandwidth method is able to be implemented on a computing device in hardware, firmware, software or any combination thereof. For example, in some embodiments, the live selective adaptive bandwidth applications 730 are programmed in a memory and executed using a processor. In another example, in some embodiments, the live selective adaptive bandwidth hardware 720 is programmed hardware logic including gates specifically designed to implement the live selective adaptive bandwidth method.

In some embodiments, the live selective adaptive bandwidth application(s) 730 include several applications and/or modules. In some embodiments, modules include one or more sub-modules as well. In some embodiments, fewer or additional modules are able to be included.

Examples of suitable computing devices include an HMD or other VR devices, a personal computer, a laptop computer, a computer workstation, a server, a mainframe computer, a handheld computer, a personal digital assistant, a cellular/mobile telephone, a smart appliance, a game console, a digital camera, a digital camcorder, a camera phone, a smart phone, a portable music player, a tablet computer, a mobile device, a video player, a video disc writer/player (e.g., DVD writer/player, high definition disc writer/player, ultra high definition disc writer/player), a television, a home entertainment system, smart jewelry (e.g., smart watch), a toy (e.g., a stuffed animal) or any other suitable computing device.

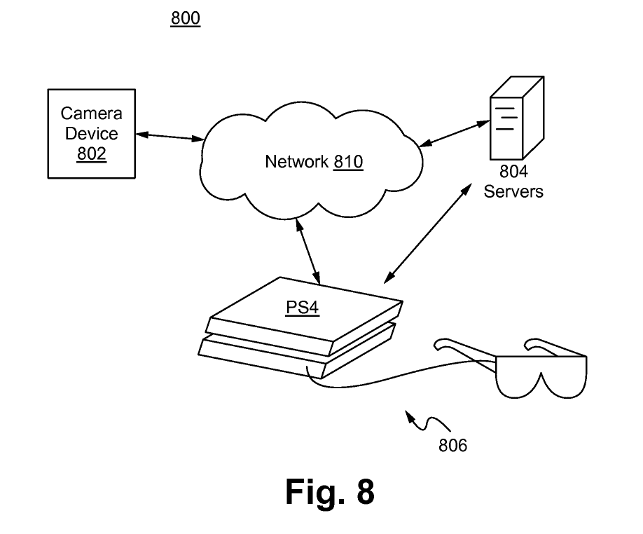

FIG. 8 illustrates a network of devices configured to implement the live selective adaptive bandwidth method according to some embodiments. The network of devices 800 is able to include any number of devices and any various devices including, but not limited to, a camera device (e.g., a 360 degree 3D camera) 802, a server device 804 and a game console with a VR headset (e.g., an HMD) 806 coupled through a network 808 (e.g., the Internet). The network 810 is able to any network or networks including, but not limited to, the Internet, an intranet, a LAN/WAN/MAN, wireless, wired, Ethernet, satellite, a combination of networks, or any other implementation of communicating. The devices are able to communicate with each other through the network 810 or directly to each other. One or more of the devices is able to be an end user device, a company device and/or another entity's device.

To utilize the live selective adaptive bandwidth method, a user accesses content using a VR device, and the content is provided to the user using the live selective adaptive bandwidth method such that the content is displayed in a high resolution when possible.

In operation, the live selective adaptive bandwidth method enables large amounts of data to be transmitted over a network and displayed properly to enable a user to enjoy a 3D VR environment.

### Some Embodiments of Live Selective Adaptive Bandwidth

1. A method programmed in a non-transitory memory of a device comprising:
   a. receiving three dimensional 360 degree virtual reality content, wherein the three dimensional 360 degree virtual reality content includes a high quality component and a lower quality component than the high quality component; and
   b. displaying the three dimensional 360 degree virtual reality content.
2. The method of clause 1 wherein the high quality component and the lower quality component each include a slice of the content.
3. The method of clause 1 wherein the high quality component includes content the user is viewing and the lower quality component includes the content the user is not viewing.
4. The method of clause 1 wherein the high quality component and the lower quality component are synchronized at a same timecode.
5. The method of clause 1 wherein the three dimensional 360 degree virtual reality content includes a plurality of qualities of content, and the quality of the content is selected based on a visible area and network information.
6. The method of clause 1 wherein the three dimensional 360 degree virtual reality content includes a plurality of qualities of content, and the quality of the content for a non-visible area is a lowest quality, and the quality of the content for a visible area is based on remaining network bandwidth available.
7. The method of clause 1 wherein the three dimensional 360 degree virtual reality content includes a plurality of resolutions and bitrates of content.
8. An apparatus comprising:
   a. a non-transitory memory for storing an application, the application for:
      i. receiving three dimensional 360 degree virtual reality content, wherein the three dimensional 360 degree virtual reality content includes a high quality component and a lower quality component than the high quality component; and
      ii. displaying the three dimensional 360 degree virtual reality content; and
   b. a processing component coupled to the memory, the processing component configured for processing the application.
9. The apparatus of clause 8 wherein the high quality component and the lower quality component each include a slice of the content.
10. The apparatus of clause 8 wherein the high quality component includes content the user is viewing and the lower quality component includes the content the user is not viewing.
11. The apparatus of clause 8 wherein the high quality component and the lower quality component are synchronized at a same timecode.
12. The apparatus of clause 8 wherein the three dimensional 360 degree virtual reality content includes a plurality of qualities of content, and the quality of the content is selected based on a visible area and network information.
13. The apparatus of clause 8 wherein the three dimensional 360 degree virtual reality content includes a plurality of qualities of content, and the quality of the content for a non-visible area is a lowest quality, and the quality of the content for a visible area is based on remaining network bandwidth available.
14. The apparatus of clause 8 wherein the three dimensional 360 degree virtual reality content includes a plurality of resolutions and bitrates of content.
15. A method programmed in a non-transitory memory of a device comprising:
   a. storing three dimensional 360 degree virtual reality content in a plurality of resolutions; and
   b. transmitting the three dimensional 360 degree virtual reality content based on a visible area and a non-visible area and network information.
16. The method of clause 15 wherein the three dimensional 360 degree virtual reality content in the plurality of resolutions includes slices of high resolution content and slices of lower resolution content.
17. The method of clause 16 wherein the high resolution content and the lower resolution content are synchronized at a same timecode.
18. The method of clause 15 wherein transmitting the three dimensional 360 degree virtual reality content includes transmitting high resolution content for the visible area and lower resolution content for the non-visible area.
19. The method of clause 15 wherein the resolution of the content for the non-visible area is a lowest resolution, and the resolution of the content for a visible area is based on remaining network bandwidth available.
20. The method of clause 15 wherein the network information includes network speed and network traffic.
21. An apparatus comprising:
   a. a non-transitory memory for storing an application, the application for:
      i. storing three dimensional 360 degree virtual reality content in a plurality of resolutions; and
      ii. transmitting the three dimensional 360 degree virtual reality content based on a visible area and a non-visible area and network information; and
   b. a processing component coupled to the memory, the processing component configured for processing the application.
22. The apparatus of clause 21 wherein the three dimensional 360 degree virtual reality content in the plurality of resolutions includes slices of high resolution content and slices of lower resolution content.
23. The apparatus of clause 22 wherein the high resolution content and the lower resolution content are synchronized at a same timecode.
24. The apparatus of clause 21 wherein transmitting the three dimensional 360 degree virtual reality content includes transmitting high resolution content for the visible area and lower resolution content for the non-visible area.
25. The apparatus of clause 21 wherein the resolution of the content for the non-visible area is a lowest resolution, and the resolution of the content for a visible area is based on remaining network bandwidth available.
26. The apparatus of clause 21 wherein the network information includes network speed and network traffic.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
a. receiving three dimensional 360 degree virtual reality content, wherein the three dimensional 360 degree virtual reality content includes a high quality component and a lower quality component than the high quality component; and
b. displaying the three dimensional 360 degree virtual reality content.

2. The method of claim 1 wherein the high quality component and the lower quality component each include a slice of the content.

3. The method of claim 1 wherein the high quality component includes content the user is viewing and the lower quality component includes the content the user is not viewing.

4. The method of claim 1 wherein the high quality component and the lower quality component are synchronized at a same timecode.

5. The method of claim 1 wherein the three dimensional 360 degree virtual reality content includes a plurality of qualities of content, and the quality of the content is selected based on a visible area and network information.

6. The method of claim 1 wherein the three dimensional 360 degree virtual reality content includes a plurality of qualities of content, and the quality of the content for a non-visible area is a lowest quality, and the quality of the content for a visible area is based on remaining network bandwidth available.

7. The method of claim 1 wherein the three dimensional 360 degree virtual reality content includes a plurality of resolutions and bitrates of content.

8. An apparatus comprising:
a. a non-transitory memory for storing an application, the application for:
i. receiving three dimensional 360 degree virtual reality content, wherein the three dimensional 360 degree virtual reality content includes a high quality component and a lower quality component than the high quality component; and
ii. displaying the three dimensional 360 degree virtual reality content; and
b. a processing component coupled to the memory, the processing component configured for processing the application.

9. The apparatus of claim 8 wherein the high quality component and the lower quality component each include a slice of the content.

10. The apparatus of claim 8 wherein the high quality component includes content the user is viewing and the lower quality component includes the content the user is not viewing.

11. The apparatus of claim 8 wherein the high quality component and the lower quality component are synchronized at a same timecode.

12. The apparatus of claim 8 wherein the three dimensional 360 degree virtual reality content includes a plurality of qualities of content, and the quality of the content is selected based on a visible area and network information.

13. The apparatus of claim 8 wherein the three dimensional 360 degree virtual reality content includes a plurality of qualities of content, and the quality of the content for a non-visible area is a lowest quality, and the quality of the content for a visible area is based on remaining network bandwidth available.

14. The apparatus of claim 8 wherein the three dimensional 360 degree virtual reality content includes a plurality of resolutions and bitrates of content.

15. A method programmed in a non-transitory memory of a device comprising:
a. storing three dimensional 360 degree virtual reality content in a plurality of resolutions; and
b. transmitting the three dimensional 360 degree virtual reality content based on a visible area and a non-visible area and network information.

16. The method of claim 15 wherein the three dimensional 360 degree virtual reality content in the plurality of resolutions includes slices of high resolution content and slices of lower resolution content.

17. The method of claim 16 wherein the high resolution content and the lower resolution content are synchronized at a same timecode.

18. The method of claim 15 wherein transmitting the three dimensional 360 degree virtual reality content includes transmitting high resolution content for the visible area and lower resolution content for the non-visible area.

19. The method of claim 15 wherein the resolution of the content for the non-visible area is a lowest resolution, and the resolution of the content for a visible area is based on remaining network bandwidth available.

20. The method of claim 15 wherein the network information includes network speed and network traffic.

21. An apparatus comprising:
a. a non-transitory memory for storing an application, the application for:
i. storing three dimensional 360 degree virtual reality content in a plurality of resolutions; and
ii. transmitting the three dimensional 360 degree virtual reality content based on a visible area and a non-visible area and network information; and
b. a processing component coupled to the memory, the processing component configured for processing the application.

22. The apparatus of claim 21 wherein the three dimensional 360 degree virtual reality content in the plurality of resolutions includes slices of high resolution content and slices of lower resolution content.

23. The apparatus of claim 22 wherein the high resolution content and the lower resolution content are synchronized at a same timecode.

24. The apparatus of claim 21 wherein transmitting the three dimensional 360 degree virtual reality content includes transmitting high resolution content for the visible area and lower resolution content for the non-visible area.

25. The apparatus of claim 21 wherein the resolution of the content for the non-visible area is a lowest resolution, and the resolution of the content for a visible area is based on remaining network bandwidth available.

26. The apparatus of claim 21 wherein the network information includes network speed and network traffic.
